(19) United States
(12) Patent Application Publication
(10) Pub. No.: US 2017/0082576 A1
(43) Pub. Date: Mar. 23, 2017

(54) An Improved Next Generation Off-Laboratory Polymer Chip Electrode

(71) Applicant: Council of Scientific & Industrial Research, New Delhi (IN)

(72) Inventors: Divesh Narayan SRIVASTAVA, Bhavnagar (IN); Mosarrat PERWEEN, Bhavnagar (IN); Rajeev GUPTA, Bhavnagar (IN); Dilip Bhimjibhai PARMAR, Bhavnagar (IN)

(21) Appl. No.: 15/309,327

(22) PCT Filed: May 8, 2015
(86) PCT No.: PCT/IN2015/000202

§ 371 Date: Nov. 7, 2016

(30) Foreign Application Priority Data
May 9, 2014 (IN) 1254/DEL/2014

(51) Int. Cl. G01N 27/48; C25C 7/02; C25B 11/12; C25C 1/16; G01N 27/30; C25B 3/02

(52) U.S. Cl. CPC G01N 27/48; G01N 27/308; C25B 3/02; C25B 11/12; C25C 1/16; C25C 7/02

(57) ABSTRACT

The present invention provides a polymer based bulk conducting electrodes. These electrodes have several advantages over the conventional screen printed and coated electrodes. The present invention also provides biodegradable variant of these electrodes. Such electrode are found comparable to the conventional noble metal electrode and glassy carbon electrode in various electrochemical techniques like cyclic voltammetry of different redox couple, amperometric sensing of hydrogen peroxide, stripping voltammetry of lead (II) ion, electrodeposition of zinc and electropolymerization of aniline in aqueous medium.

### FIELD OF THE INVENTION

The present invention relates to low cost next generation robust bulk conducting and self standing polymer chip electrode for off-laboratory applications.

### BACK GROUND OF THE INVENTION

The current generation off-laboratory electrodes comprise mostly screen-printed and coated (PVD & CVD) electrodes. The major drawback of these electrodes is that the conducting components are not the integral part of the device, which get damaged/delaminated easily either by mechanical jerk, high deposition, high current or aging.

The electrodes made from conventional plasticizing polymers were called “Plastic Chip Electrode” (PCE) whereas it's another variant made with biodegradable plasticizing polymers were called “Biodegradable Plastic Chip electrode” (BPCE). Such electrodes were found comparable to the conventional noble metal and glassy carbon electrodes in various electrochemical applications like cyclic voltammetry of different redox couples, amperometric sensing of hydrogen peroxide, stripping voltammetry of heavy metals, electrodeposition of zinc and electropolymerization of aniline and 3,4-ethylenedioxythiophene in aqueous medium.

The most ancient mercury electrodes are not considered safe even for lab application due to its toxic and bio-accumulative nature. Carbon paste electrodes are fit for the lab-applications, albeit due to the morphological constrains and flabby nature, their practice in field-applications is not so convenient. Moreover they are not self-standing and the template supporting the carbon paste is an unwarranted species in the electrode. However the screen-printed electrodes due to its flat and sleek, self-standing, two dimensional geometry fits well for the field, on-site as well as more advanced applications like interdigitated array electrodes and lab-on-a-chip. Albeit the bottleneck with coated and screen printed electrodes is that the conducting layers are not the integral part of the composite and can easily get delaminated due to mechanical jerk or high current. Therefore, there was a need for an improved alternative of the surface coated electrodes having similar potentials but minimized shortcomings. Current invention addresses these problems. A flat, bulk-conducting and self-standing two dimensional electrode using graphite-polymer composite have been fabricated and used as electrode. Biodegradable polymer, poly (lactic acid) was also used in order to introduce environment-friendly and greener aspects in these electrodes. The kinetics of biodegradability of the BPCE was studied and compared with biodegradability of the pristine polymer used for its fabrication.

There are some related prior art which need to mention here to understand novelty of current invention. Although no similar product to subject electrodes is known

Reference may be made to the article by Jaroslav Heyrovsky, Philosophical Magazine 45 (1923) 303-315, where electrolysis of the alkali and alkaline earth metals over the dropping mercury electrode (DME) is reported. In DME a drop of mercury at the tip of capillary tube was used as electrode.

Reference may be made to the patent by B. A. Heller, RU55100, Jun. 30, 1939 and by Oscar Kanner; Edwin D. Coleman, U.S. Pat. No. 2,361,295, Oct. 24, 1944 where several modification in DME is reported for better applications of these electrodes.

Reference may be made to the article by J. Heyrovshy, The Analyst, 72 (1947) 229-234, where he explained the application of DME in polarography.

Reference may be made to the article by V. F. Gaylor, A. L. Conrad and J. H. Landerl, Anal. Chem. 29 (1957) 224 where wax-impregnated graphite electrode was reported.

Reference may be made to the article by R. N. Adams, Anal. Chem. 30 (1958) 1576 where carbon paste electrode through the dropping carbon electrode was reported.

Reference may be made to several patents where carbon paste electrodes were used in various applications; for example: in supercapacitor (JP 57046208B; 1 Jun. 1973), double layer capacitor (JP 59090919A; 25 May 1982), voltammetry (SU 1985-3981899; 21 Nov. 1985), electroanalysis (SU 1557510A1; 15 Apr. 1990).

Reference may be made to the patent by Skotheim, Terje; Okamoto, Yoshiyuki; Gorton, Lo G.; Lee, Hung Sui; Hale, Paul U.S. Pat. No. 5,264,092A; 23 Nov. 1993 where the enzyme modified carbon paste electrode was used for making biosensor.

Reference may be made to the patent by Don N. Gray; George G. Guilbault, U.S. Pat. No. 3,929,609, A, 30 Dec. 1975 where a solid sensor electrode versatile than conventional noble-metal electrodes was fabricated by screen printing a mixture of the noble metal and a low-alkali glass on an inert substrate.

Reference may be made to the patent by Joseph, Wang; Ziad H. Taha, WO 9218857, A1 29 Oct. 1992, where trace metal testing was performed over the screen printed electrode by electrochemical flow injection method.

Reference may be made to the patent by Rebecca Y. Lai; Weiwei Yang, US 20110139636, A1; 16 Jun. 2011, where screen printed sensor cartridge comprising working, counter and reference electrode on a single chip for electrochemical sensor has been reported.

Reference may be made to the patent by Vijaywant, Mathur; Chander Raman Suri; Priyanka Sharma, IN 2010CH00236, A, 25 May 2012, where screen printed biochip is reported.

Reference may be made to the patent by J. Yu, Y. Zheng, H. Li, J. Li; CN 103448308 A 20131218, where biodegradable flexible conductive substrate and its manufacturing method is reported.

Reference may be made to the patent by Q. Liu, B. Deng; CN 102943315 A 20130227, where production of poly(lactic acid)-based conductive fibers is reported.

Reference may be made to the patent by T. Suzuki, Y. Hirabayashi, M. Yoneda, A. Maruyama; JP 2005032633 A 20050203, where coating of conducting composite of biodegradable polymers like polybutylene succinate, polybutylene succinate adipate, polyethylene succinate, polylactic acid, poly-ε-caprolactone, poly-3-hydroxybutyrate, poly (3-hydroxybutyrate-3-hydroxyvalerate), and/or polyglycolic acid is reported. The coated electrodes were then used as cathode and anode in Li batteries.

Reference may be made to the article by R. P. Pawar, S. U. Tekale, S. U. Shisodia, J. T. Totre, A. J. Domb; Recent Patents on Regenerative Medicine (2014), 4(1), 40-51, where various Biomedical Applications of Poly(Lactic Acid) is discussed.

Reference may be made to the patent by Y. Fukuhira, E. Kitazono, H. Kaneko, Y. Sumi, Y. Narita, H. Kagami, Y. Ueda, M. Ueda; WO 2006115281 A1 20061102, where application of poly(Lactic Acid) in cardiac pacemaker is reported.

Reference may be made to the article by S. Peng, P. Zhu, Y. Wu, S. G. Mhaisalkar, S. Ramakrishna; RSC Advances (2012), 2(2), 652-657, where polyaniline-polylactic acid composite nano-fibers were used as counter electrodes in dye-sensitized solar cells.

### Objects of the Invention

The main object of this present invention is to develop low cost, portable and bulk conducting electrodes which can be presented as a superior alternative for the conventional and expensive electrodes such as gold, platinum or other noble metal electrodes and coated electrodes like screen printed electrodes by a simple fabrication steps.

Another object of the present invention is to develop disposable and self-standing polymer composite electrodes which can be used directly after fabrication without any template or support (as in carbon paste electrodes) or thermal curing steps (as in screen printed electrodes).

Yet another object of the present invention is to adopt simple technique (solution casting method) for the fabrication of electrodes.

Yet another object of the invention is to develop a protocol for fabrication of electrodes withreproducible physical dimensions and conductivity.

Yet another object of the present invention is to try various polymers in combination with graphite for the formation of plastic chip electrode.

Yet another objective of this investigation is to incorporate environment-friendly and greener aspect in the plastic chip electrodes by using biodegradable polymer.

Yet another objective of the present investigation is to study the kinetics of biodegradability of the BPCE and compare it with the pristine poly (lactic acid).

Another object of the present investigation is to test PCE and BPCE in various electrochemical processes.

### SUMMARY OF THE INVENTION

Accordingly, the present invention provides a self-standing polymer chip electrode comprising graphite and polymer in the weight ratio ranging between 70:30 to 40:60, wherein the polymer used is selected from the group consisting of poly (methyl methacrylate) (PMMA), polystyrene (PS) and polyvinyl chloride (PVC) for non-biodegradable electrodes; or poly (lactic acid) (PLA) for biodegradable electrodes.

In an embodiment, present invention provides a process for the preparation of electrode comprising the steps of:
i. preparing a polymer solution by dissolving a polymer in a solvent by sonication and heating till complete dissolution of the polymer;
ii. mixing graphite and the polymer solution prepared in step (i) in a weight ratio ranging between 70:30 to 40:60 to obtain a mixture;
iii. sonicating the mixture as obtained in step (ii) for a period in the range of 10 to 15 minutes to obtained a uniformly disperse suspension;
iv. flooring a glass mould with a polyester sheet which is insoluble in organic solvent as a template with the provision of pulling off;
v. pouring the suspension obtained in step (iii) over the glass mould obtained in step (iv) to obtain a film over the glass mould;
vi. drying the film obtained in step (iv) for 24 hours at room temperature in the range of 25-30° C. by slow evaporation; and
vii. cutting the film followed by removing of polyester template to obtain the electrode.

In yet another embodiment of the present invention, the thickness of the film having graphite: polymer weight ratio in the range from 70:30 to 40:60 is in the range of 0.5 mm to 0.42 mm for 48.99 cm² casting area and 3 gm total mass.

In yet another embodiment of the present invention, electrical conductivity of the electrode having graphite: polymer weight ratio in the range from 70:30 to 40:60, when various polymer are used is in the range of 2.3×10⁻² S/cm to 1.1×10⁻¹¹ S/cm.

In yet another embodiment of the present invention, the thermal stability of the electrode is up to 300° C.

In yet another embodiment of the present invention, the polymer used is selected from the group consisting of poly (methyl methacrylate) (PMMA), polystyrene (PS), polyvinyl chloride (PVC) and poly (lactic acid) (PLA).

In yet another embodiment of the present invention, the solvent used is selected from the group consisting of chloroform and tetrahydrofuran.

Another embodiment of the present invention provides an electrode for use in electrochemistry and electroanalysis in aqueous media.

In yet another embodiment of the present invention, the electrodeis useful as a working electrode in cyclic voltammetry of various redox couples in aqueous medium, electropolymerization of aniline and 3,4-ethylenedioxythiophene in aqueous medium, electrowinning of zinc, amperometric sensing of hydrogen peroxide and anodic stripping voltammetry of Pb (II) ion.

In yet another embodiment of the present invention, the electrode is useful as a working electrode for electrodeposition of zinc and copper aniline and 3,4-ethylenedioxythiophene.

In yet another embodiment of the present invention, other plasticizing or biodegradable plasticizing polymers can be used in place of poly (methyl methacrylate) (PMMA), polystyrene (PS), polyvinyl chloride (PVC) and poly (lactic acid) (PLA).

In yet another embodiment of the present invention, the electrode can be used for any electrochemical process in aqueous media.

In yet another embodiment of the present invention, the electrode is useful as working electrode in cyclic voltammetry of various redox couples such as Ru^{2+/3+}, ferrocene/ferrocenium, and Fe^{2+/3+}in aqueous system.

In yet another embodiment of the present invention, the electrode is useful for amperometric sensing of hydrogen peroxide in a wide concentration window (9 μM to 400 μM) with sensitivity of 0.42 μA μM⁻¹.

In yet another embodiment of the present invention, the electrodes is used for detection of various heavy metals via stripping voltammetry with a lower detection limit 100 ppb.

### BRIEF DESCRIPTION OF ACCOMPANYING DRAWINGS

FIG. 1 represents percentage mass loss (% Δm) of BPCE electrode (as obtained in example 11) vs. time of degradation caused by protease enzyme in 0.1 M buffer solution of Tris-HCl of pH=8 at 37° C.

FIG. 2 represents Surface AFM topograph of BPCE degraded with time by protease enzyme: (a) Fresh prepared BPCE surface, (b) at 4th day, (c) at 8th day, (d) at 12^{th} day, (e) at 16^{th} day.

FIG. 3A represents cyclic voltammogram of ferrocyanide/fericyanideredox couple recorded on PCE-PMMA-II electrode. [In-set—Corresponding peak current vs. square root of scan-rate plot for cathodic as well as anodic scans]. Details are given in example 12.

FIG. 3B represents cyclic voltammogram of ferrocene/frroceniumredox couple recorded on PCE-PMMA-II electrode. [In-set—Corresponding peak current vs. square root of scan-rate plot for cathodic as well as anodic scans]. Details are given in example 12.

FIG. 3C represents cyclic voltammogram of [Ru(bpy)₃]⁺²/[Ru(bpy)₃]⁺³redox couple recorded on PCE-PMMA-II electrode. [In-set—Corresponding peak current vs. square root of scan-rate plot for cathodic as well as anodic scans]. Details are given in example 12.

FIG. 4A represents cyclic voltammogram of electropolymerization of aniline on PCE-PMMA-II composite electrode acid.Details are given in example 13.

FIG. 4B represents cyclic voltammogram of electropolymerization of 3,4-ethylenedioxythiophene on BPCE composite electrode. Details are given in example 13.

FIG. 5 shows chronoamperometric response recorded at −0.2 V vs. Ag/AgCl for successive addition of 100 μL of 1 mM H₂O₂. [Inset: calibration curve of limiting current vs. concentration of H₂O₂]. PCE-PMMA-II composite was used as working electrode. Details are given in example 14.

FIG. 6 represents chronopotentiometric curve for electrodeposition of zinc at different current densities using PCE-PMMA-II composite as working electrode. [Inset: Cyclic voltammogram of Zn⁺² recorded at 50 mV/s scan rate] as describe in example 15.

FIG. 7 represents stripping step of differential pulse anodic stripping voltammetry for Pb⁺² on PCE-PMMA-II composite electrode at various concentrations of the analyte. [In-set-corresponding calibration curve]. Details are given in example 16.

### DETAILED DESCRIPTION OF THE INVENTION

Present invention relates to a cost effective, self-standing and bulk conducting disposable electrode fabricated from the composite of graphite and polymer. This invention also relates to the introduction of environment-friendly and greener aspect in these electrodes by using biodegradable polymer. The invention recognized that graphite is very cheap and easily available conducting material suitable for the purpose of electrode fabrication. In order to obtain self-standing, bulk conducting electrodes, the graphite was composited with plasticizing polymer in suitable ratio. Solution casting method was chosen for making electrode film recognizing its ease and simplicity. The electrode was cut in required shape. The biodegradability of the electrode was checked through enzymatic and hydrolytic degradation processes and its kinetics was studied with gel permeation chromatography.The electrodes were applied successfully in various electrochemical techniques such as cyclic voltammetry, electrochemical polymerization, amperometric sensing and stripping voltammetry.

In current invention a flat, self-standing, two dimensional and bulk conducting polymer composite sheet was fabricated by simple solution casting method and used as electrode.

Accordingly, a self-standing, bulk conducting and cost effective electrode materials is disclosed. The detail description of the invention is given in following points.
(i) Preparing a polymer solution by dissolving a polymer in a suitable solvent by sonication and heating till complete dissolution of the polymer;
(ii) Mixing graphite in the polymer solution with the help of glass rod according to the graphite-polymer weight ratio and area of casting to obtain a mixture;
(iii) Sonication of the mixture for 10 minutes to obtained a uniformly disperse suspension;
(iv) Flooring a glass mould with a commercially available polyester sheet, which is insoluble in organic solvents as a template with the provision of pulling off;
(v)Pouring the suspension after stirring with glass rod over the glass mould to obtain a film over the glass mould;
(vi) Drying the film for 24 hours at room temperature by slow evaporation;
(vii) Cutting the film in appropriate size according to the requirement with the help of a cutter; and
(viii) Removing the polyester template from the film to obtain the electrode.

The novel inventive steps related to the present invention are as follows:
1. Recognizing that the bare conventional electrodes are limiting to the expanding dimensions of the electrochemistry, therefore tailored and low cost electrodes are highly demanded for the sustainable growth in electrochemistry.
2. Recognizing that graphite is a very good choice as electrode material owing to its low cost, wide inert potential window, relatively inert electrochemistry and electrocatalytic activity, graphite can be utilized as conducting source for making electrode.
3. Recognizing that the plasticizing properties of various polymers such as poly (methyl methacrylate), polystyrene, polyvinyl chloride can be used for making two dimensional composite with graphite which produced bulk conducting and self-standing electrodes [hereafter called Plastic Chip Electrode (PCE)].
4. Recognizing that the biodegradability of poly (lactic acid) along with plasticizing property can be utilized to introduce environment-friendly and greener aspect in PCE [hereafter called BiodegradablePlastic Chip Electrode (BPCE)].
5. Further recognizing the simplicity of solution casting method, it can be adopted for the fabrication of composite electrodes by means of graphite dispersion in polymer solution in organic solvent.
6. Further demonstrating that a fixed total amount of materials (graphite and polymer) for a certain casting area can produce film of similar physical properties (thickness and conductivity), the method is adopted for composite electrode fabrication of pre-decided dimensions.
7. Further demonstrating the ease of cutting of composite film into pieces and removal of polyester sheet are encountered.
8. Further recognizing that the comparable degradation kinetics of the BPCE with that of pure polymer (PLA), can be chosen for the preparation of biodegradable electrodes.
9. Further recognizing that the PCE and BPCE can efficiently function as electrode in several electrochemical methods such as cyclic voltammetry, amperometric sensing of hydrogen peroxide, stripping voltammetry for the detection of lead (II) ion, electropolymerization of aniline and 3, 4-ethylenedioxythiophene and electrodeposition of the zinc are concerned.
10. Further recognizing that the surface as well as bulk modification in such composite electrodes can be easily made for the application based utility.

### EXAMPLES

Following examples are given by way of illustration and should not be construed to limit the scope of the invention.

Material and methods

Poly (methyl methacrylate) (PMMA) was taken as representative polymer for preparing Plastic Chip Electrode (PCE) in different weight ratios of graphite:polymer viz. 70:30, 60:40, 40:60 and 20:80 denoted as PCE-PMMA-I, PCE-PMMA-II, PCE-PMMA-III and PCE-PMMA-IV respectively. The thickness and conductivity of the film of different graphite:PMMA weight ratio is given in table 1. Various other polymers suchas polystyrene, polyvinyl chloride and poly (lactic acid) were used for fabrication of electrodesby maintaining graphite:polymer weight ratio 60:40 which are denoted as PCE-PS, PCE-PVC and BPCE respectively. The thickness, conductivity, total mass of materials, casting area and the solvent used for making of electrode using various polymers are shown in table 2.

TABLE 1
The thickness and conductivity of the graphite-polymer
film prepared in different weight ratio (graphite:polymer)
and casted in two different areas.

| | Area = 48.99 cm² | | Area = 15.89 cm² | |
|---|---|---|---|---|
| | Thickness | Conductivity | Thickness | Conductivity |
| Electrodes | (mm) | (Scm⁻¹) | (mm) | (Scm⁻¹) |
| PCE-PMMA-I | 0.50 | 2.2 × 10⁻² | 0.50 | 2.3 × 10⁻² |
| PCE-PMMA-II | 0.42 | 1.6 × 10⁻² | 0.42 | 1.6 × 10⁻² |
| PCE-PMMA-III | 0.45 | 1.0 × 10⁻⁵ | 0.46 | 1.0 × 10⁻⁵ |
| PCE-PMMA-IV | 0.44 | 1.1 × 10⁻¹¹ | 0.43 | 1.0 × 10⁻¹¹ |

graphite:PMMA weight ratio; PCE-PMMA-I = 70:30; PCE-PMMA-II = 60:40; PCE-PMMA-III = 40:60; PCE-PMMA-IV = 20:80

TABLE 2
Thickness, conductivity and the solvent used for making
graphite-polymer composite electrode using various
polymers in 60:40 weight ratio (graphite:polymer).

| | | | Total | | |
|---|---|---|---|---|---|
| | Thick- | | mass of | | |
| | ness | Conductivity | materials | Casting | Solvent |
| Electrodes | (mm) | (Scm⁻¹) | (gm) | area (cm²) | used |
| PCE- | 0.42 | 1.6 × 10⁻² | 3 | 48.99 | Chloroform |
| PMMA-II | | | | | |
| PCE-PS | 0.41 | 3.1 × 10⁻² | 3 | 48.99 | Chloroform |
| PCE-PVC | 0.43 | 1.2 × 10⁻³ | 3 | 62.18 | THF |
| BPCE | 0.38 | 2.0 × 10⁻³ | 5 | 100 | Chloroform |

PCE-PMMA-II = electrode with weight ratio of graphite:PMMA 60:40, PCE-PS = electrode with weight ratio of graphite:polystyrene 60:40, PCE-PVC = electrode with weight ratio of graphite:polyvinyl chloride 60:40, THF = tetrahydrofuran.

Current-voltage (I-V) measurements were performed using a Keithley 2635A source meter unit (SMU) by applying a range of bias voltage and measuring corresponding current. For this purpose, the film was cut into 1 cm×1 cm size and sandwiched between two platinum foils and placed in a spring loaded brass holder. The holder was connected to the source meter unit (SMU) through a crocodile clip. Bias voltage inthe range ±100 mV was applied for PCE-PMMA-I, PCE-PMMA-II, PCE-PS, PCE-PVC and BPCE while ±1.0 V for PCE-PMMA-III and ±10.0 V for PCE-PMMA-IV.The data were collected and plotted to obtain the I-V curve. The electrical conductance of the films was calculated from the slope of the curve. The specific conductance was calculated by using the formula, σ=G×1/A, where 1 is thickness, A is area and G is the electrical conductance of the film respectively. The pH measurements of solutions were carried out using Thermo Scientific (ORION VERSASTAR) pH meter at room temperature calibrated every time before use. All electrochemical experiments were performed on Princeton Applied Research potentiostat (PARSTAT 2273) at room temperature (24±2° C.). A three-electrode assembly was used during electrochemical measurements where composite film (0.8 cm width and 3 cm length) was used as working electrode, while platinum foil and Ag/AgCl (saturated KCl) were used as auxiliary and reference electrode respectively. The working length on working electrode was maintained at 0.5 cm by applying Teflon tape over the unused area. The electrical contact in the working electrode was made through a crocodile clip, which was suitably modified for the purpose. PCEs and BPCE were characterized for the surface morphology by a scanning electron microscope (SEM) (LEO 1430 VP) after thin coating of conducting Au—Pd alloy, and by an atomic force microscope (AFM) (NT-MDT Ntegra Aura) without any pre-treatment over a 0.8×2 cm-sized sample. Tensile tests of the electrodes were carried out using a universal testing machine (Zwick Roell, type X force P, Ser. No. 756,324), applying a preload of 0.01 N at 0.2 mm/min.

The specimen dimensions for the tensile test were 8×0.45×35 mm (w×t×l). The thermal stability of the electrodes were examined by thermogravimetric analysis (TGA) (NETZSCH, TG 209 F1, libra), taking 30 mg of sample. The measurements were performed from 25° C. to 600° C. at a heating rate of 10° C./min in nitrogen atmosphere.

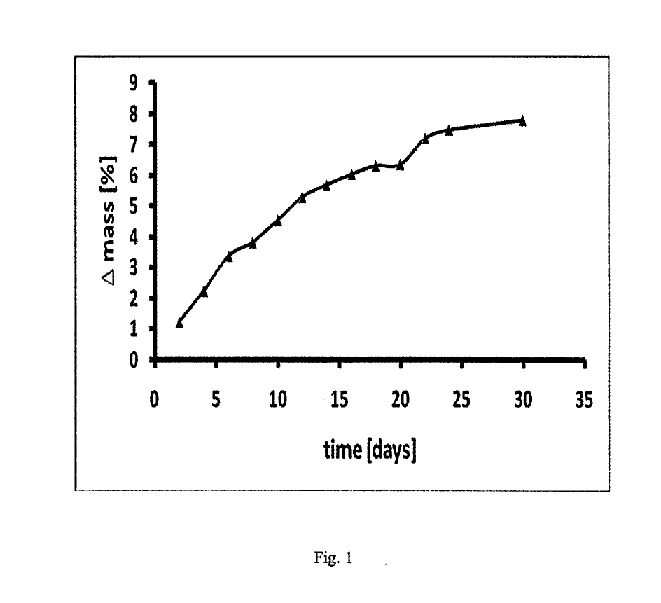

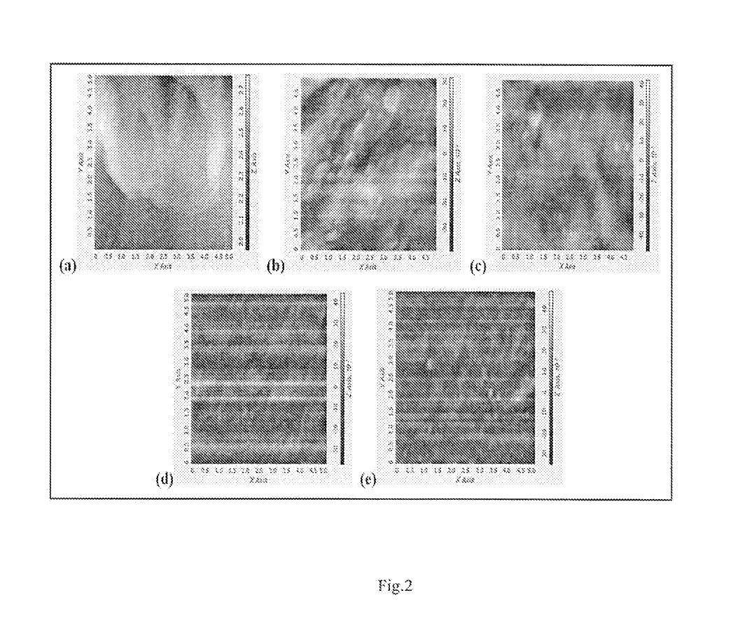

Enzymatic degradation of biodegradable plastic chip electrode was studied using protease enzyme in 0.1M Tris-HCl buffer (pH 8). The BPCE was kept in the buffer solution at 37° C. and residual mass was taken after every 2 days. For this purpose sample was removed from solution, carefully washed with milli-Q water and dried in vacuum desiccators. Weight of dried sample was taken with a balance (readability 0.001 mg) and percentage loss in mass (% Δm) was calculated by the formula: % Δm=[(mᵢ−m_{f})/mᵢ]×100. Where mᵢ is initial mass and m_{f} (at time t) is final mass of BPCE. % Δm was plotted with respect to time which is given in FIG. 1. Pitting on the surface structure of BPCE due to biodegradation was evaluated from the AFMover a 0.5×0.5 cm-sized sample. (FIG. 2).

Hydrolytic degradation of BPCE and PLA film were measured in Milli-Q water thermostated at 58° C. Several pieces of PLA and BPCE film of same thickness weighing around 50 mg were placed in separate beakers having 25 gm of water (weight ratio of water:film 500:1). In every 48 hours, pH of liquids in each beaker was measured and then water was removed by sucking with a syringe. All other beakers were filled with fresh Milli-Q water and kept thermostated (58° C.) for further hydrolytic degradation, except one each of PLA films and BPCE. The spared chips were dried at 58° C. for 2.5 hours and stored in air tight plastic pouches for further analysis. A definite portion of degraded films were cut and dissolved in tetrahydrofuran (THF) at 58° C. The graphite was removed from the solution by centrifugation process and supernatant was taken out for analysis. The molecular weight distribution measurements were carried out by HPLC using Waters 2695 separations module coupled with Waters 2414 RI Detectors.

The kinetics (rate constant and half-life) of hydrolytic degradation of PLA and BPCE films was studied by the help of Gel Permeation Chromatography (GPC) by measuring the decrease in molecular weight of the polymer. The following formulas were used to calculate rate constant and half-life considering that the degradation follows first order kinetics:

$$- k = \frac{d ln ( {M}_{n} - M )}{d t}$$

$$and$$

$${t}_{1 / 2} = \frac{0.693}{k}$$

Where, ‘k’ is the rate constant of the hydrolysis process. ‘Mₙ’ is number average molecular mass at time ‘t’ during hydrolysis process, ‘M’ is the molecular weight of the repeating unit which is 72 g/mol and t_{1/2} is half-life.

### Example 1

9 ml of 10% (w/v) poly (methyl methacrylate) (PMMA) solution (made by dissolving PMMA in chloroform) was taken in a beaker and 2.1 gm of graphite was added to it. The graphite:polymer weight ratio was 70:30 (PCE-PMMA-I). The mixture was stirred and sonicated for 10 minutes. The suspension was spread over modified glass mould of area 48.99 cm². The system was kept for drying for 24 hours at room temperature (25° C.). The thickness and conductivity of the film was 0.5 mm and 2.2×10⁻² S/cm respectively.

### Example 2

3 ml of 10% (w/v) PMMA solution (made by dissolving PMMA in chloroform) was taken in a beaker and 0.7 gm of graphite was added to it. The graphite:polymer weight ratio was 70:30 (PCE-PMMA-I). The mixture was stirred and sonicated for 10 minutes. The suspension was spread over modified glass mold of area 15.89 cm². The system was kept for drying for 24 hours at room temperature (27° C.). The thickness and conductivity of the film was 0.5 mm and 2.3×10⁻² S/cm respectively, which is same to the film formed in experiment-1, within the limits of experimental errors.

### Example 3

12 ml of 10%(w/v) PMMA(made by dissolving PMMA in chloroform) solution was taken in a beaker and 1.8 gm of graphite was added to it. The graphite:polymer weight ratio was 60:40 (PCE-PMMA-II). The mixture was stirred and sonicated for 10 minutes. The suspension was spread over modified glass mold of area 48.99 cm².

The system was kept for drying for 24 hours at room temperature. The thickness and conductivity of the film was 0.42 mm and 1.6×10⁻² S/cm respectively.

### Example 4

4 ml of 10% (w/v) PMMA(made by dissolving PMMA in chloroform) solution was taken in a beaker and 0.6 gm of graphite was added to it. The graphite:polymer weight ratio was 60:40 (PCE-PMMA-II). The mixture was stirred and sonicated for 10 minutes. The suspension was spread over modified glass mold of area 15.89 cm². The system was kept for drying for 24 hours at room temperature. The thickness and conductivity of the film was 0.42 mm and 1.6×10⁻² S/cm respectively, which is same to the film formed in experiment-3, within the limits of experimental errors.

### Example 5

18 ml of 10% (w/v) PMMA(made by dissolving PMMA in chloroform) solution was taken in a beaker and 1.2 gm of graphite was added to it. The graphite:polymer weight ratio was 40:60 (PCE-PMMA-III). The mixture was stirred and sonicated for 10 minutes. The suspension was spread over modified glass mold of area 48.99 cm². The system was kept for drying for 24 hours at room temperature. The thickness and conductivity of the film was 0.45 mm and 1.0×10⁻⁵ S/cm respectively.

### Example 6

6 ml of 10% (w/v) PMMA(made by dissolving PMMA chloroform) solution was taken in a beaker and 0.4 gm of graphite was added to it. The graphite:polymer weight ratio was 40:60 (PCE-PMMA-III). The mixture was stirred and sonicated for 10 minutes. The suspension was spread over modified glass mold of area 15.89 cm². The system was kept for drying for 24 hours at room temperature. The thickness and conductivity of the film was 0.46 mm and 1.0×10⁻⁵ S/cm respectively, which is same to the film formed in experiment-5, within the limits of experimental errors.

### Example 7

24 ml of 10% (w/v) PMMA (made by dissolving PMMA chloroform) solution was taken in a beaker and 0.6 gm of graphite was added to it. The graphite:polymer weight ratio was 20:80 (PCE-PMMA-IV). The mixture was stirred and sonicated for 10 minutes. The suspension was spread over modified glass mold of area 48.99 cm². The system was kept for drying for 24 hours at room temperature. The thickness and conductivity of the film was 0.44 mm and 1.1×10⁻¹¹ S/cm respectively.

### Example 8

8 ml of 10% (w/v) PMMA (made by dissolving PMMA chloroform) solution was taken in a beaker and 0.2 gm of graphite was added to it. The graphite:polymer weight ratio was 20:80 (PCE-PMMA-IV). The mixture was stirred and sonicated for 10 minutes. The suspension was spread over modified glass mold of area 15.89 cm². The system was kept for drying for 24 hours at room temperature. The thickness and conductivity of the film was 0.43 mm and 1.0×10⁻¹¹ S/cm respectively, which is same to the film formed in experiment-7, within the limits of experimental errors.

### Example 9

12 ml of 10% (w/v) polystyrene (made by dissolving polystyrene in chloroform) solution was taken in a beaker and 1.8 gm of graphite was added to it. The graphite:polymer weight ratio was 60:40 (noted as PCE-PS). The mixture was stirred and sonicated for 10 minutes. The suspension was spread over modified glass mold of area 48.99 cm². The system was kept for drying for 24 hours at room temperature. The thickness and conductivity of the film was 0.41 mm and 3.1×10⁻² S/cm respectively, which is same to the film formed in experiment-3 & 4, within the limits of experimental errors.

### Example 10

1.52 gm polyvinyl chloride dissolved in 20 ml of hot tetrahydrofuranwith continuous stirring. 2.28 gm of graphite then added to it and mixed with the help of glass rod. The graphite:polymer weight ratio was 60:40 (noted as PCE-PVC). The mixture was sonicated for 10 minutes by maintaining the temperature at around 60° C. The suspension was spread over modified glass mold of area 62.18 cm². The thickness and conductivity of the film was 0.43 mm and 1.2×10⁻³ S/cm respectively.

### Example 11

20 ml of 10% (w/v) poly (lactic acid) (made by dissolving PLA in chloroform) was taken in a beaker and 3 gm of graphite was added to it. The graphite:polymer weight ratio was 60:40(noted as BPCE). The mixture was stirred and sonicated for 10 minutes. The suspension was spread over modified glass mold of area 100 cm². The system was kept for drying for 24 hours at room temperature. The thickness and conductivity of the film was 0.38 mm and 2.0×10⁻³ S/cm respectively.

### Example 12

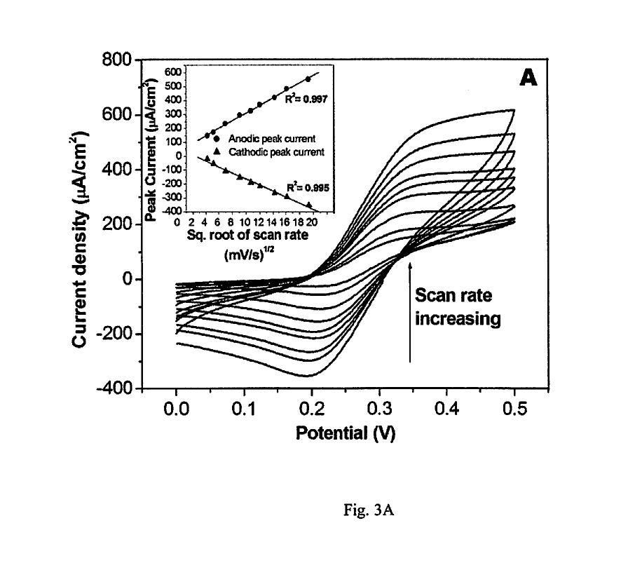

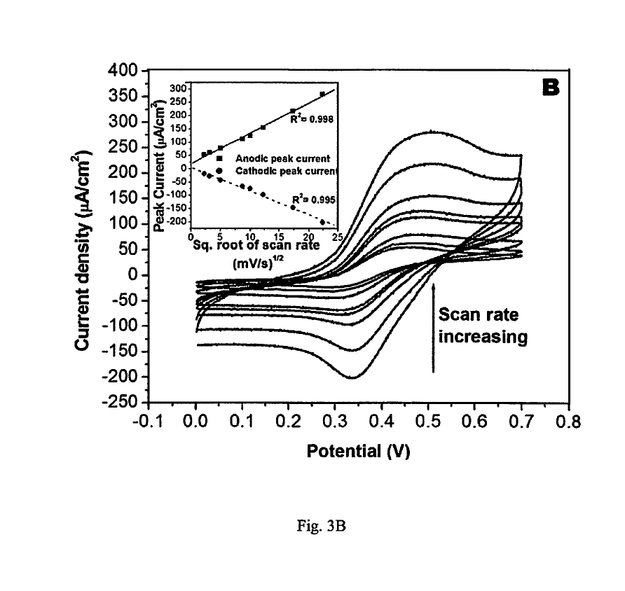

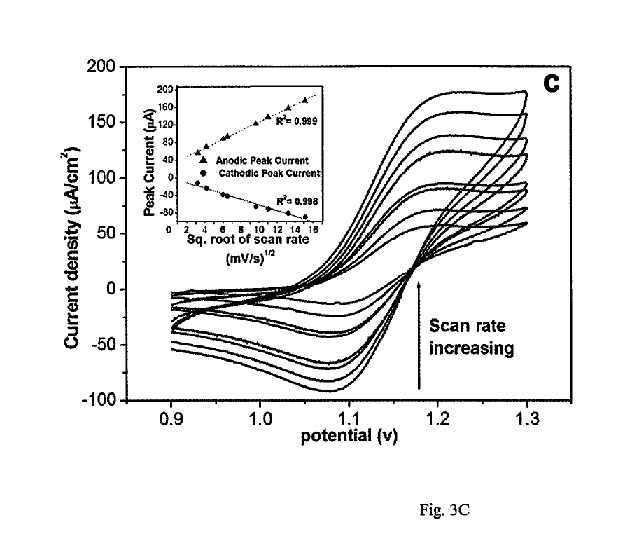

PCE-PMMA-II was used as working electrode for the measurement of cyclic voltammogram of ferrocyanide/ferricyanide(FIG. 3A)ferrocene/ferrocenium (FIG. 3B) and Ru(bpy)₃]²⁺/[Ru(bpy)₃]³⁺couple (FIG. 3C) at different scan rate using potassium ferrocyanide (10 mM), ferrocene carboxylic acid (3 mM) in 0.1 M acetate buffer pH 4.5 and tris (2,2′-bipyridyl)-dichlororuthenium(II) hexahydrate (1 mM) in 0.1 M potassium nitrate solution respectively. The data on formal potential) (E⁰, anodic and cathodic peak current (Iₚₐ and I_{pc}) and peak to peak separation (ΔE) for all redox couple at 100 mV/s scan rate is give in table 3.

TABLE 3
The redox parameters derived from the cyclic voltammogram of
ferrocyanide/fericyanide; [Ru(bpy)₃]⁺²/[Ru(bpy)₃]⁺³ and
ferrocene/ferrocenium redox couples at 100 mV/s scan rate.
PCE-PMMA-II was used as working electrode for these studies.

| Redox couples | E⁰ (V) | ΔE (V) | Iₚₐ (μA/cm²) | I_{pc}(μA/cm²) |
|---|---|---|---|---|
| ferrocyanide/ferricyanide | 0.273 | 0.147 | 369.51 | −217.0 |
| [Ru(bpy)₃]^{+2/+3} | 1.143 | 0.133 | 137.87 | −71.21 |
| ferrocene/frrocenium | 0.394 | 0.128 | 124.33 | −74.45 |

E⁰ = formal potential calculated by taking the mean of the cathodic and anodic peak potentials, ΔE = difference between anodic and cathodic peak potential, Iₚₐ = anodic peak current, I_{pc} = cathodic peak current.

This example demonstrates that the electrode shows super Nernstian behavior (ΔE larger than 59 mV/s for one electron transfer and Iₚₐ>I_{pc}) for all three redox couples which is characteristics of graphite composite electrodes.

### Example 13

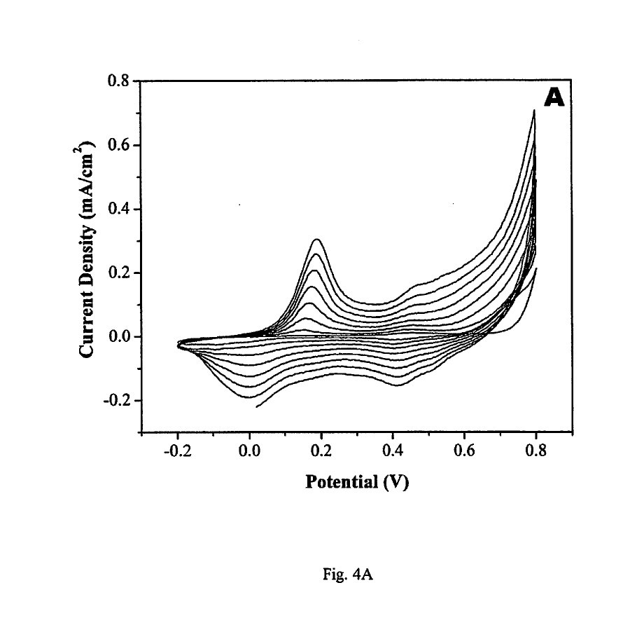

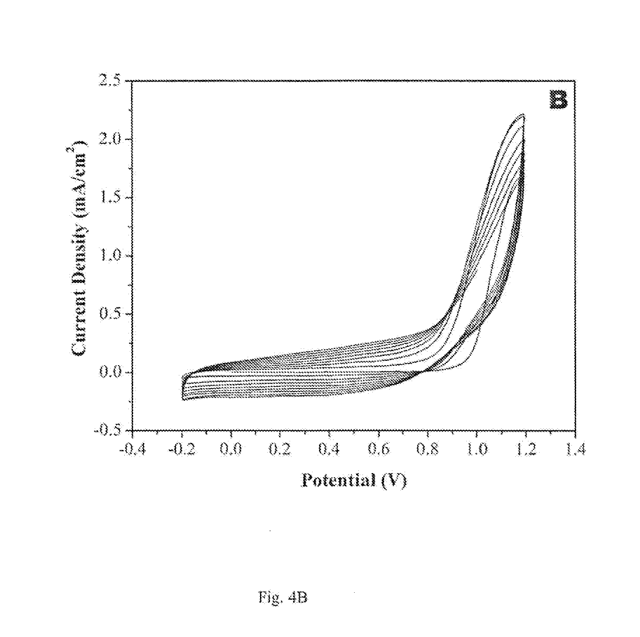

Effort was made for anodic oxidation of aniline to form polyaniline via electropolymerization using PCE-PMMA-II and BPCEas working electrode. For this purpose, asulphatemonomer of aniline was prepared by dissolving 0.1M aniline in 0.5 M H₂SO₄ followed by sonication for 4-5 minutes. Freshly prepared aniline monomer was taken in 10 ml beaker and polymerization was carried out by cycling the potential in −0.2V to 0.8 V range for 9 cycles at 50 mV/s scan rate. The cyclic voltammograms for the electropolymerization of aniline overboth the electrodes are given in FIG. 4A. Electropolymerization of 3,4-ethylenedioxythiophene (EDOT) was also attempted using BPCE as working electrode. A 0.01M monomer solution of EDOT was prepared in 0.1M KCl as supporting electrolyte. Total nine cycles were given for potentiodynamic polymerization at the scan rate 50 mV/s in the range from −0.2 V to 1.2 V (FIG. 4B).

This example demonstrates that the PCE & BPCEcan be used effectively for the electropolymerization.

### Example 14

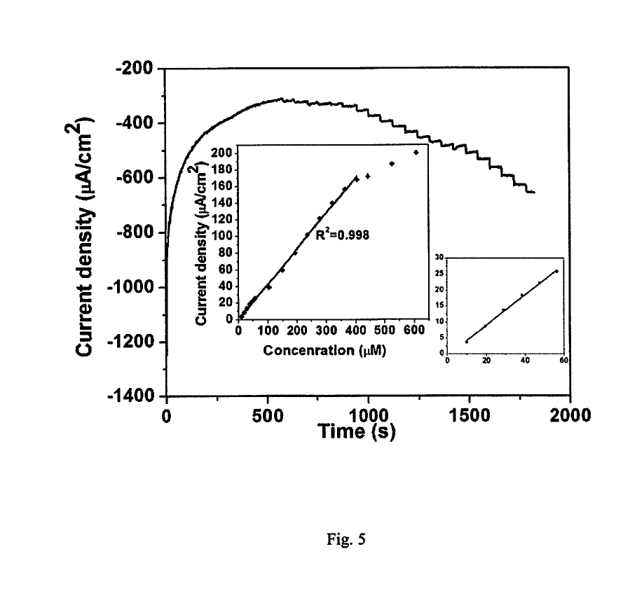

PCE-PMMA-II was used as working electrode for the non-enzymatic amperometric sensing of hydrogen peroxide. For this purpose, a stock solution of 1 mM H₂O₂ was prepared in 0.1 M phosphate buffer (pH 5.2). A constant potential −0.2V was applied and responses were recorded by successive addition of 100 □L of stock solution under stirring condition. The addition of stock solution was started after attainment of steady state (constant current) at an interval of 1 minute. The chronoamperometric graph for H₂O₂ sensing is given FIG. 5.

This example shows that non enzymatic amperometric detection of hydrogen peroxide can be performed using PCE. The responses were found to be instantaneous linear (R²=0.998) in wide concentration window (9 μM to 400 μM). The sensitivity was found to be 0.42 μA/μM and lower detection limit was 9 μM.

### Example 15

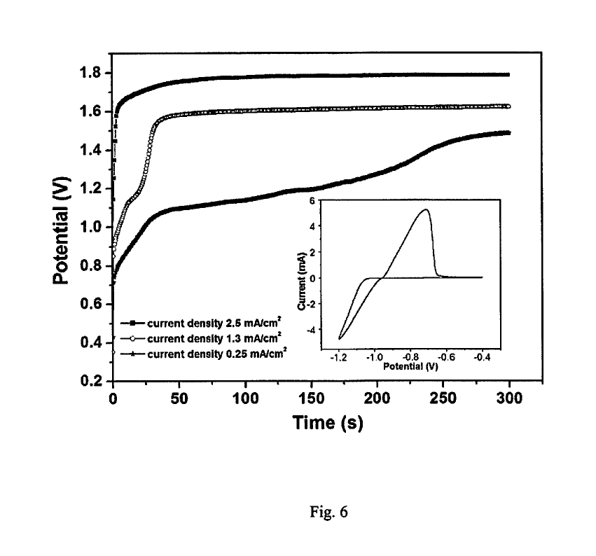

Galvenostatic electrowinning of zinc was tried on the PCE-PMMA-II electrode using a solution having zinc (167.5 g/L), manganese (5.5 g/L), and iron (7 g/L). Three different current densities viz. 0.25, 1.25 and 2.25 mA/cm² were examined for the zinc deposition (FIG. 6) for a fixed period of time (300 seconds).

This example demonstrates that these electrodes can be effectively used for the electrowinning purpose.

### Example 16

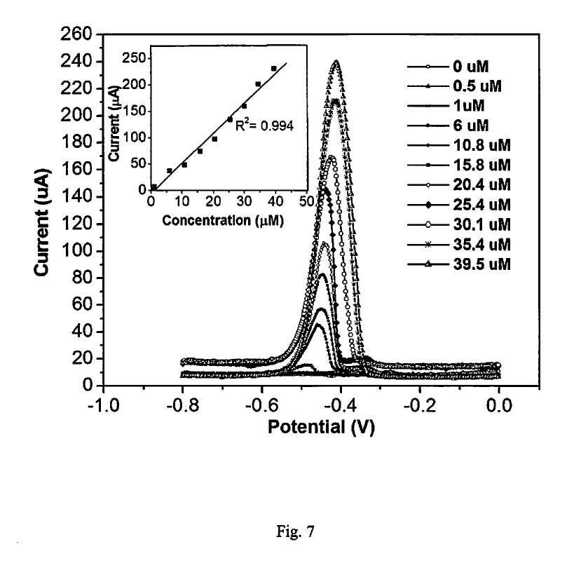

Anodic stripping voltammetric (ASV) for the detection of lead was attempted on PCE-PMMA-II using it as working electrode. A stock solution (1 mM) of lead nitrate was prepared in acetate buffer (0.1M) pH 4.5 for this purpose. Several solutions of lead ranging from 0.5 □M to 40 □M were prepared by successive dilution of stock solution with same buffer. Electrodeposition was carried out by applying −1.2V for 5 minutes with continuous stirring. The voltammogram (FIG. 7) was recorded after 5 seconds equilibration by applying differential pulse voltammetry by maintaining potential range −0.8 V to 0 V, pulse width 25 mV for 50 msec, step height 2 mV and step time 100 msec. A blank experiment (without any analyte) was run under similar conditions to check the background current. A new working electrode was used for each measurement. The peak current was normalized with the background current and was used to draw the calibration curve (in-set of FIG. 5) which was found to be linear in 1 μM to 40 μM concentration range with a coefficient of regression (R²) 0.994.

### Advantages of the Invention

The advantages of the present invention are
i. Use of graphite as electrode material which is highly conducting and inexpensive with a wide potential window, electrocatalytic activity and relatively inert electrochemistry.
ii. Freedom from surface delamination of conducting layer as in case of screen printed and coated electrodes.
iii. Bulk conductivity of the electrode made of two dimensional composite of graphite with plasticizing polymer.
iv. Self-standing structure of the electrode without any template.
v. Ease of preparation of the electrode through simple solution casting method.
vi. Enormous possibilities of bulk as well as surface modifications. Bulk modification can be made during preparation of electrode by mixing the modifier in graphite-polymer slurry. While, surface modifications can be made over the dried electrode surface either in-situ during measurement or by casting modifier on electrode.
vii. Stiffness in dimension. The electrode made with a fixed ratio of total amount of material (graphite+polymer) with casting area having similar physical properties (thickness and conductivity).
viii. Flexibility in size. Since, the electrode made as a film, it can be cut in any size according to the requirement.
ix. Inclusion of environment-friendly and greener aspect through the utilization of biodegradable polymers in the electrode.

1. A self-standing polymer chip electrode comprising graphite and a polymer in the weight ratio ranging between 70:30 to 40:60, wherein the polymer used is selected from the group consisting of poly (methyl methacrylate) (PMMA), polystyrene (PS) and polyvinyl chloride (PVC) for non-biodegradable electrodes; or poly (lactic acid) (PLA) for biodegradable electrodes,
wherein said electrode has thickness in the range of 0.42 mm to 0.50 mm and electrical conductivity in the range of 2.3×10⁻² S/cm to 1.1×10⁻¹¹ S/cm.

2. A process for the preparation of electrode as claimed in claim 1 comprising the steps of:
(i) preparing a polymer solution by dissolving a polymer in a solvent by sonication and heating till complete dissolution of the polymer;
(ii) mixing graphite and the polymer solution prepared in step (i) in a weight ratio ranging between 70:30 to 40:60 to obtain a mixture;
(iii) sonicating the mixture as obtained in step (ii) for a period in the range of 10 to 15 minutes to obtained a uniformly disperse suspension;
(iv) flooring a glass mould with a polyester sheet which is insoluble in an organic solvent as a template with the provision of pulling off;
(v) pouring the suspension obtained in step (iii) over the glass mould obtained in step (iv) to obtain a film over the glass mould;
(vi) drying the film obtained in step (iv) for 24 hours at room temperature in the range of 25-30° C. by slow evaporation; and
(vii) cutting the film followed by removing of polyester template to obtain the electrode.

3. The process as claimed in claim 2, wherein the thickness of the film having graphite: polymer weight ratio in the range from 70:30 to 40:60 is in the range of 0.5 mm to 0.42 mm for 48.99 cm² casting area and 3 gm total mass.

4. The process as claimed in claim 2, wherein electrical conductivity of the electrode having graphite: polymer weight ratio in the range from 70:30 to 40:60, when various polymers are used is in the range of 2.3×10⁻² S/cm to 1.1×10⁻¹¹ S/cm.

5. The process as claimed in claim 2, wherein the thermal stability of the electrode is up to 300° C.

6. The process as claimed in claim 2, wherein the polymer used is selected from the group consisting of poly (methyl methacrylate) (PMMA), polystyrene (PS), polyvinyl chloride (PVC) and poly (lactic acid) (PLA).

7. The process as claimed in claim 2, wherein the solvent used is selected from the group consisting chloroform and tetrahydrofuran.

8. The electrode as claimed in claim 1 for use in electrochemistry and electroanalysis in aqueous media.

9. The electrode as claimed in claim 1, wherein physical dimensions of said electrode are controlled by fixing total amount of graphite and polymer for a certain casting area.
